(19) United States
(12) Patent Application Publication
(10) Pub. No.: US 2015/0054619 A1
(43) Pub. Date: Feb. 26, 2015

(54) Distress Signal for Notifying Potential Rescuers of Victims Trapped in a Structure

(71) Applicant: HITBox Alarm Co, L.L.C., Mustang, OK (US)

(72) Inventors: John Bohlen, Mustang (UG); Richard Evans, JR., Mustang, OK (US); Jerry Randall, Mustang, OK (US)

(73) Assignee: HITBox Alarm Co., L.L.C., Mustang, OK (US)

(21) Appl. No.: 14/465,649

(22) Filed: Aug. 21, 2014

Related U.S. Application Data
(60) Provisional application No. 61/868,615, filed on Aug. 22, 2013.

(51) Int. Cl. G08B 25/12; G08B 25/10

(52) U.S. Cl. CPC G08B 25/12; G08B 25/10
USPC 340/7.5; 29/428

(57) ABSTRACT

A distress signaling system capable of withstanding natural disasters, manmade disasters, and other similar events comprising audible and visual signaling devices; a radio frequency receiver/transmitter system; powered by a rechargeable power source coupled with solar cells; and optionally a GPS emergency beacon, a two way communicator, a camera, and an cellular phone application activator; and an installation form enabling the consumer to quickly and easily install the system with no specialized tools or knowledge.

### CROSS-REFERENCE TO RELATED APPLICATIONS

Priority is claimed from provisional application U.S. Ser. No. 61/686,615 filed on Aug. 22, 2013, and incorporated by reference herein.

### FIELD OF THE INVENTION

In general, this invention (10) relates to systems and methods for alerting potential rescuers of victims trapped in structures after natural disasters, manmade disasters, and similar events. More in particular, the present invention (10) generally provides a distress signal system capable of withstanding natural disasters, manmade disasters, and other similar events that can quickly be installed by the end user using an installation form and emits both audible and visual signals notifying first responders and individuals that survivors are trapped within a nearby structure.

### DESCRIPTION OF RELATED ART

After every natural disaster or manmade disaster, a team of first responders and individuals begin the long and arduous task of locating survivors trapped in affected structures. The first 24 hours of every search and rescue operations are the most critical. As such, a number of personal locator beacons relying on radio frequencies have been marketed to the public to aid rescuers in locating trapped survivors. These devices, and other, similar radio devices can lead searchers to a general location over vast distances. But, they rely on specialized equipment to receive the distress signal. Many first-responder operations, however, are volunteer operations manned by individuals from surrounding communities armed with nothing more than the simplest tools and their desire to help those in need. These volunteer operations are rarely outfitted with the equipment necessary to receive the distress signal of these highly specialized transmitters. Unfortunately, by the time professional teams capable of receiving the distress signals transmitted by these personal locator beacons arrive, a significant amount of time has generally passed.

Other devices, such as building security systems, provide a more localized signal. But, this is limited by the fact that they are installed on the structure itself and rely on the structure's infrastructure for power. Thus, any significant damage to the structure renders these devices inoperable. Additionally, these devices are limited by the fact the fact that installation require specialized tools and technical knowledge. As such, this technology is not readily available for a lay person, to install and use.

Therefore, there is a present need for a distress signal that can be observed and relied upon by potential rescuers equipped with only the simplest of tools, that is self contained, easily installed without specialized knowledge or tools, capable of withstanding the elements, and capable of withstanding the destructive forces of natural disasters, manmade disasters, and other similar events.

### SUMMARY OF THE INVENTION

A distress signaling device which emits a high intensity light and alarm to aid potential rescuers in identifying a structure containing trapped victims that is easy for the consumer to install, maintain, and operate.

### BRIEF DESCRIPTION OF THE INVENTION

The present invention (10) takes advantage of existing technology to create a solution that meets the needs of the average homeowner rather than focusing the niche market of technologically savvy individuals. To accomplish this objective, the inventors looked at the aftermath of tornados and other natural disasters to determine the natural focus point of potential rescuers canvassing an affected neighborhood. The inventors determined that most potential rescuers travel by automobile or foot making the most natural location for a distress signal at grade near the public street. By installing the invention (10) near the public street, the invention (10) allows potential rescuer to quickly identify structures with trapped survivors without leaving their automobile or searching the structure itself. Further, by placing the invention (10) at grade, the invention's (10) exposure to the damaging forces of natural disasters, such as tornados, is limited.

In addition to recognizing the importance of the invention's (10) location, the inventors recognized that the distress signal needed to be self contained and capable of reliably “running off the grid.” To this end, in the inventors took advantage of rapidly improving solar cell technology and rechargeable batteries.

The invention (10) is designed to allow the average homeowner to install the invention (10) with nothing more than a shovel, a bucket and some water. To further simplify installation, the invention (10) requires no external wiring and takes advantage of radio frequency transmitters and receivers to activate and deactivate the distress signaling device.

The invention (10) provides a platform for more sophisticated locating technologies, such as COSPAS-SARSAT transceivers, GPS transceivers, and any other common radio wave transmitter.

The invention (10) also provides a platform for a two way transmitter/receiver that has the ability to send active feedback to the trapped victims via radio waves, email, and short message service (“SMS”) or text messages to notify the trapped victims that the invention (10) successfully activated, to be added to the invention (10).

Value for the end user is provided in part because the invention (10) provides peace of mind that rescuers will be notified they are trapped inside the structure. The early notification also guarantees a reduction in time before their rescue. Further value may be provided by incorporating the device into existing alarm systems, which allows the invention (10) to be used to signal a disturbance within the structure, such as a break-in or a domestic dispute.

The invention (10) has, among others, the following three major design aspects: (a) signaling system; (b) a water resistant enclosure; and (c) an installation form that allows the invention (10) to quickly be installed at grade with the simplest of tools.

The signaling system preferably comprises of (a) electric circuitry that couples a piezoelectric alarm, a strobe module and light emitting diodes; (b) a solar cell for receiving sunlight and for generating a charging current; (c) a rechargeable power source coupled to the above described solar cell for receiving the generated current and charging as a result; (d) a radio frequency receiver coupled to the above described power source and to a control circuit which switches on and off the piezoelectric alarm, the strobe module and light emitting diodes; (e) an antenna coupled to the radio frequency receiver; (f) a handheld radio frequency transmitter powered by a common battery is supplied with the invention (10) so as to supply a signal to the invention (10) that allows the invention (10) to be turned on remotely; (g) and expansion ports that allow the consumer to quickly and easily add optional accessories after the invention (10) is installed.

The enclosure preferably comprises of (a) a body having two components, a lens and a bottom component, with a peripheral area for mating engagement to ensure a relatively sealed relationship when the components are closed; (b) a modular design that separates the heat generating electronics from the heat sensitive electronics; and (c) a locking mechanism that prevents unwanted access to the interior of the enclosure. The lens is preferably constructed of a single piece of rigid polycarbonate that shields the delicate electronics from harmful ultraviolet radiation without diminishing the solar cells effectivity. The bottom component is also preferably constructed of rigid polycarbonate material.

The modular design comprises of an insulating barrier that horizontally divides the interior of the physical enclosure. The insulating barrier is preferably constructed of a material with sufficient insulating properties to protect heat sensitive components from temperatures in excess of their maximum operating temperatures. The heat tolerant components, such as the piezoelectric alarm, the solar cell, and the light emitting diodes are mounted to the top side of the insulating barrier. Heat sensitive components, such as the radio frequency receiver and the strobe module, are installed below the insulating barrier. This design ensures the electronic components are never exposed to temperatures in excess of their maximum operating temperature regardless of the external temperature or run time, which increases the longevity and reliability of the invention (10).

The installation form preferably comprises: (a) a plastic polymer or similarly rigid material formed into a open topped structure with a horizontal support shelf and apertures in the horizontal and vertical surfaces. The enclosure described above is attached to the top of the horizontal support shelf.

There have thus been outlined, rather broadly, the more important features of the invention (10) in order that the detailed description thereof that follows may be better understood, and in order that the present contribution to the art may be better appreciated. There are, of course, additional features of the invention (10) that will be described hereinafter.

In this respect, before explaining at least one embodiment of the invention (10) in detail, it is to be understood that the invention (10) is not limited in this application to the details of construction and to the arrangements of the components set forth in the following description or illustrated in the drawings. The invention (10) is capable of other embodiments and of being practiced and carried out in various ways. Also, it is to be understood that the phraseology and terminology employed herein are for the purposes of description and should not be regarded as limiting. As such, those skilled in the art will appreciate that the conception, upon which this disclosure is based, may readily be utilized as a basis for designing of other structures, methods and systems for carrying out the several purposes of the present invention (10). Additional benefits and advantages of the present invention (10) will become apparent in those skilled in the art to which the present invention (10) relates from the subsequent description of the preferred embodiment, taken in conjunction with the accompanying drawings. It is important, therefore, that the claims be regarded as including such equivalent constructions insofar as they do no depart from the spirit and scope of the present invention (10).

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention (10) of the application, which is measured by the claims, nor is it intended to be limiting as to the scope of the invention (10) in any way.

### DESCRIPTION OF THE DRAWINGS

FIG. 1 is a detailed view of the distress signal system (100), according to a preferred embodiment of the present invention (10).

FIG. 2 is an isometric view of the installation form used to anchor the distress signaling device, according to a preferred embodiment of the present invention (10).

FIG. 3 is a top view of the lower component of the enclosure and the components installed therein, according to a preferred embodiment of the present invention (10).

FIG. 4 is a side view of the enclosure, which demonstrates the approximate location of the insulating barrier, according to a preferred embodiment of the present invention (10).

FIG. 5 is a top view of the lens and the functional components installed therein, according to a preferred embodiment of the present invention (10).

FIG. 6 is a top view of the insulating barrier and demonstrates the approximate location of solar cell, piezoelectric alarm, and light emitting diodes, according to a preferred embodiment of the present invention (10).

FIG. 7 is a side view of the insulating barrier and demonstrates the approximate location of the light emitting diodes, according to a preferred embodiment of the present invention (10).

FIG. 8 is an exploded view of the invention (10).

FIG. 9 is a diagram of the fully installed invention (10).

### DETAILED DESCRIPTION OF THE INVENTION

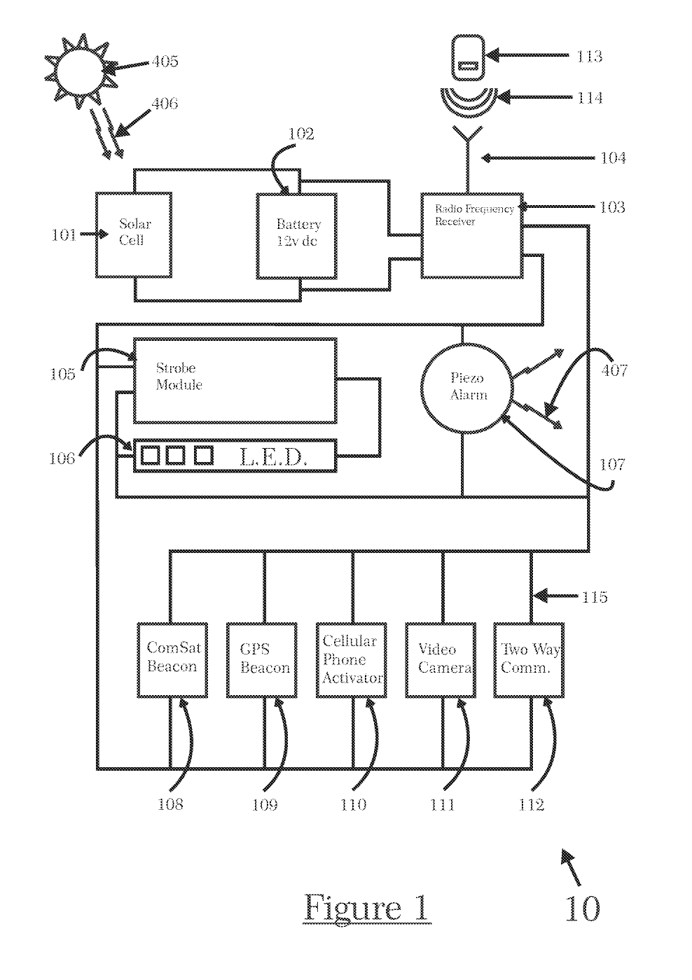

FIG. 1 illustrates, in greater detail, an embodiment of a system consistent with the present invention (10). The solar cells (101) are part of a circuit which includes a rechargeable power source (102). In other embodiments the circuit may also include a diode and a voltage regulator and filter capacitor. Such a circuit is well known to those skilled in the art. The first lead from the solar cells (101) is coupled to the positive terminal of the rechargeable power source (102). In another embodiment the first lead from the solar cells (101) may be coupled to the positive terminal of the rechargeable power source (102) via a diode, which ensures that the current can only travel in the desired direction. In another embodiment, a regulator and filter capacitor may be connected in parallel with the rechargeable power source (102), which ensures optimum battery life and high energy retention.

The rechargeable power source (102) may take the form of any of many rechargeable batteries known in the art, is preferably light weight and inexpensive, and can supply about 11 to 12 volts. In the preferred embodiment, the rechargeable power source is a lithium polymer battery and is used to power the radio frequency receiver (103) and the signaling system. The signaling system consists of a strobe module (105), the light emitting diodes (106), the piezoelectric alarm (107), and when utilized other components, such as a COSPAS-SARSAT emergency beacon (108), a GPS emergency beacon (109), a cellular phone application activator (110), a video camera (111), and any manner of two way communication devices (112). (033) In another embodiment, the solar cell (101) is replaced by a battery charger known to those skilled in the art that is housed within the invention's (10) enclosure. The battery charger is connected to the structures electrical circuit which provides a constant charge source to the rechargeable power source. In this embodiment, a wire preferably encased in a protective conduit is installed between the structure and the invention (10).

In another embodiment, the rechargeable power source is housed within the structure. A battery charger known to those skilled in the art replaces the solar cells and is connected to the structures electrical circuit which provides a constant charge to the battery. In this embodiment, a wire preferably encased in a protective conduit is installed between the structure and the invention (10).

In the preferred embodiment, the radio frequency receiver (103) and handheld radio frequency transmitter (113) operates in a frequency range (114) known to those skilled in the art and takes advantage of the rolling codes. An antenna (104) is coupled to the radio frequency receiver (103) extending the functional range of the invention (10).

When the radio frequency receiver (103) detects a signal from the handheld radio frequency transmitter, the circuit between the rechargeable power source and the distress system is opened. When a second signal from the handheld radio frequency transmitter (113) is detected, the circuit between the rechargeable power source (102) and the distress system is closed.

In another embodiment, when the radio frequency receiver (103) detects a signal from the handheld radio frequency transmitter (114), the circuit between the rechargeable power source and any number of additional components, such as COSPAS-SARSAT emergency beacon (108), a GPS emergency beacon (109), a cellular phone application activator (110), a video camera (111), and any manner of two way communication devices (112), is opened. When a second signal from the handheld radio frequency transmitter (113) is detected, the circuit between said optional equipment and the rechargeable power source (102) is closed.

In another embodiment, the radio frequency receiver (103) is replaced with a switch installed within the structure that opens and closes the circuit between the rechargeable power source (102) and the distress signaling system. In this embodiment, a wire preferably encased in a protective conduit is installed between the structure and the invention (10).

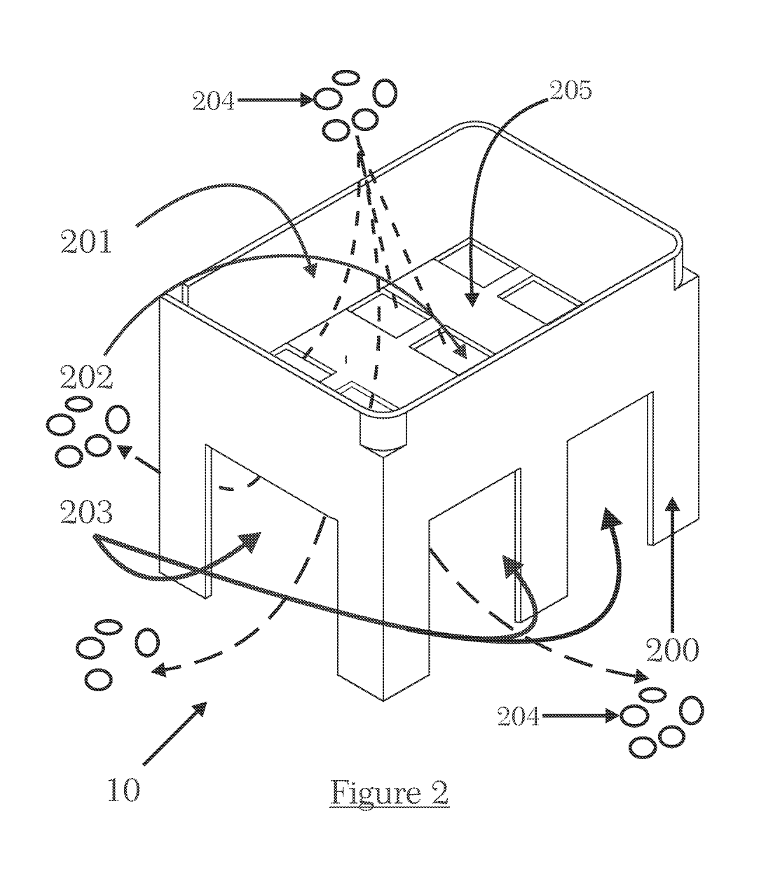

FIG. 2 illustrates an installation form (200) consistent with that used in the present invention (10). A rigid material is formed into a box with an open top (201), a plurality of apertures in the horizontal surface (202) and ports in the vertical surfaces (203) to allow a composite material to pass through the plurality of apertures (202) in the horizontal surface (205) and spill into the void surrounding the invention. The enclosure is attached on the horizontal surface (205) of the installation form (200).

The consumer digs a hole (802) near the street with dimensions greater than those of the installation form (200). The invention (10) is then placed into the hole (802). The consumer then uses shims or excavated dirt to level the lens of the physical enclosure at grade. The consumer then pours a predefined amount of composite material, such as concrete, cement or other similar material, into the installation form. The composite material passes through the aperture on the horizontal surface (202) and the ports in the vertical surfaces (203) allowing the composite material to flow into the voids surrounding the installation form. Enough composite material is used to encapsulate the installation form (200) in composite material. Once the composite material has set, the hole is backfilled covering the installation form (200) and the excess composite material that escaped through the ports in the vertical surfaces (203). The installation form (200) when combined with the excess composite material anchors the invention in the ground.

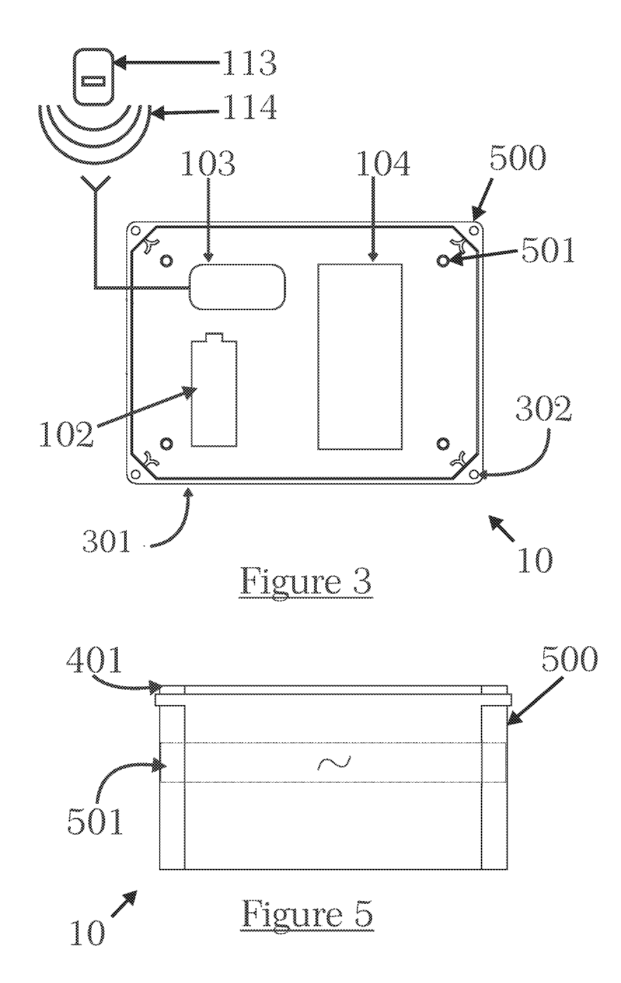

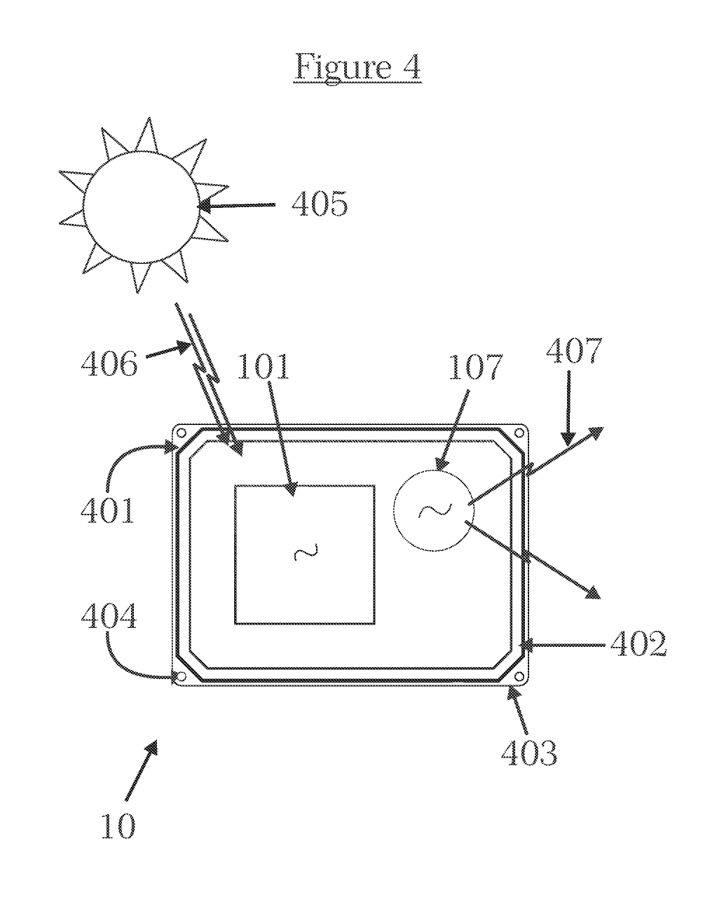

FIG. 3 illustrates the bottom component of the physical enclosure (500) made of rigid material, such as polycarbonate or similar material. The bottom component of the physical enclosure (500) includes a peripheral lip (301) extending around the periphery for mating with the lens (as shown in FIG. 4). This ensures a relatively closed relationship when the bottom component (500) and lens (400) are closed. The peripheral lip includes a hole at each corner (302) that lines up with a hole at each corner of the top component (404). When closed, a bolt and nut or similar fastener combination is used to close and seal interior of the enclosure from the elements.

In another embodiment, the bottom component of the enclosure (500) is molded into the horizontal surface (205) of the installation form (200).

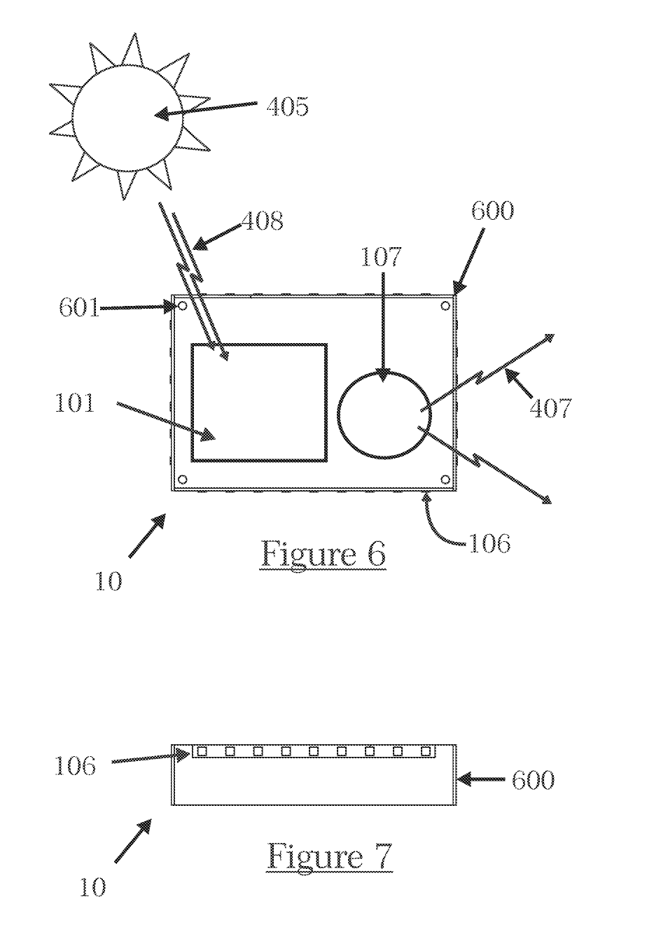

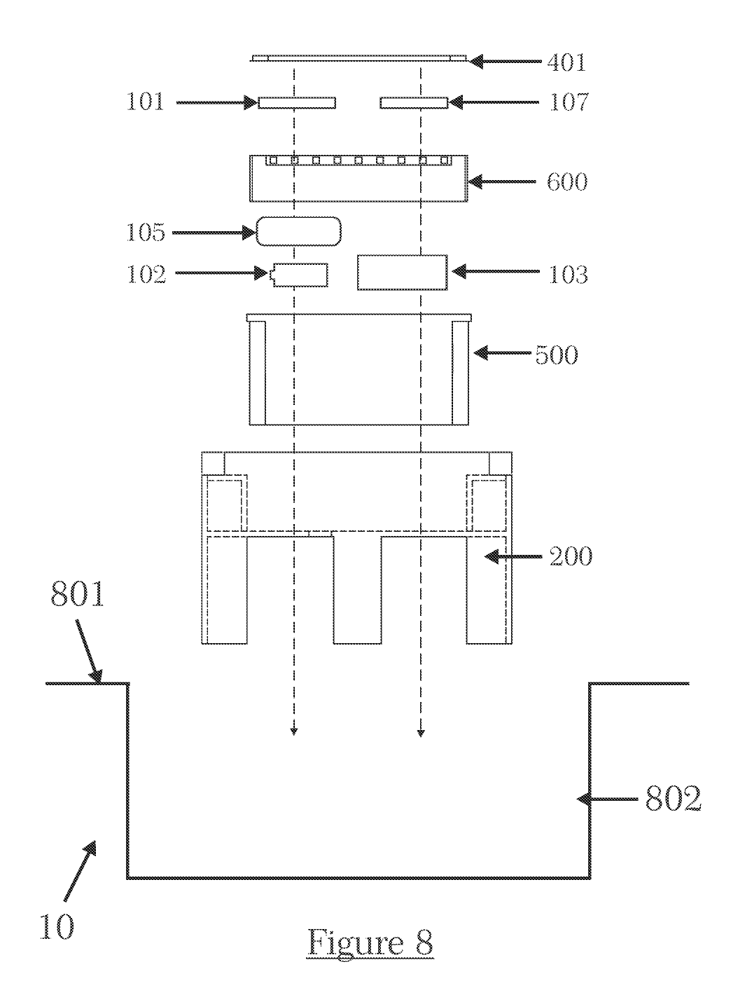

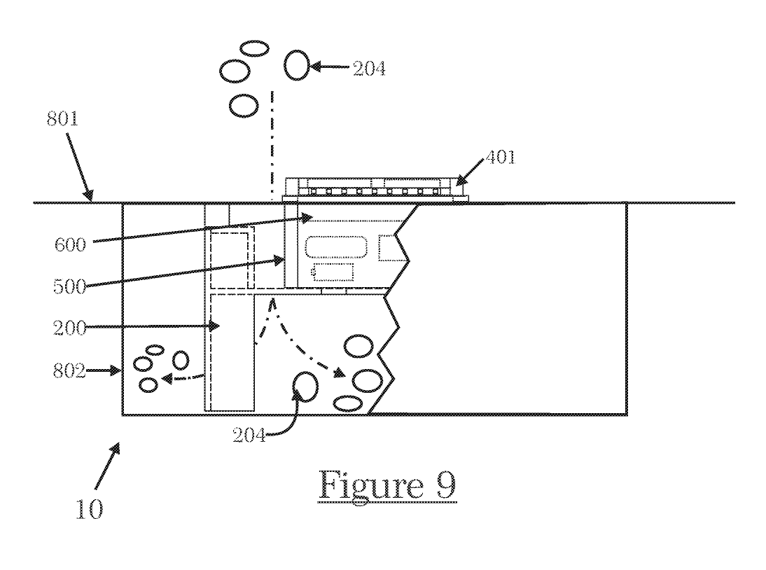

Heat sensitive equipment is mounted below the insulating barrier (shown in FIGS. 6 and 7) in the bottom component of the enclosure. The heat sensitive components mounted below the insulating barrier include: the rechargeable power source (102), the radio frequency receiver (103), and the strobe module (105).

FIG. 4 illustrates the lens (401) made of a translucent, rigid material, such as polycarbonate or similar material. The lens (401) includes a peripheral lip (403) extending around the periphery for mating with the bottom component of the enclosure (as shown in FIG. 3). This ensures a relatively closed relationship when the lens (401) and bottom component (500) are closed. The peripheral lip includes a hole at each corner (404) that lines up with a hole at each corner of the bottom component (302). When closed, a bolt and nut or similar fastener combination is used to close and seal interior of the enclosure from the elements. The lens of the physical enclosure has an elevated edge where the light emitting diodes are mounted (402). FIG. 4 also illustrates the location of the solar cells (101) and the piezoelectric alarm (107). In the preferred embodiment, the lens (401) is lined with a reflective coating that protects the sensitive electronic components from harmful ultraviolet radiation.

FIG. 5 illustrates an exterior side view of the enclosure (500) and the location of the insulating barrier (501). FIG. 5 also illustrates the elevated edge on the lens of the physical enclosure (401) which allows the light emitting diodes (as shown in FIGS. 1 and 7) to be seen from all angles.

FIG. 6 illustrates the top of the insulating barrier (600) with the solar cells (101) and the piezoelectric alarm (107) mounted to the top surface. Light emitting diodes (106) are mounted to the vertical edge of the insulating barrier.

FIG. 7 illustrates a side view of the insulating barrier with the light emitting diodes (106) mounted to the vertical edge of the insulating barrier.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

While the invention has been shown, illustrated, described, and disclosed in terms of specific embodiment or modifications, the scope of the invention should not be deemed to be limited by the precise embodiments or modifications therein shown, illustrated, or described or disclosed. Such other embodiments or modifications are intended to be reserved especially as they fall within the scope of the application.

Having thus described the invention, we claim:

1. A distress signaling device used to notify rescuers of victims trapped in a structure comprising of:
a. an enclosure that is water resistant,
b. a signaling system including
i. a rechargeable power source,
ii. a solar cell for changing the rechargeable power source,
iii. a switch to remotely activate the distress signaling device,
iv. a sound generating means to emit an alarm,
v. a high intensity light,
vi. electrical circuitry to couple the rechargeable power source, the solar cell, the radio frequency receiver, the sound generating means, and the high intensity light
c. an installation form, wherein the installation form has a horizontal surface to support the distress signaling device and a plurality of apertures to pour composite material through and vertical surfaces with ports allowing the composite material to flow into the voids around the distress signaling device and encapsulating the installation form
whereby the distress signal can be easily installed and allow the consumer to enlist any individual located near the structure as a potential rescuer, without the need of locating equipment or training, simply by following the sound and light emitted from said distress signaling device to the collapsed structure.

2. The device of claim 1, wherein the enclosure is made of polycarbonate.

3. The device of claim 1, wherein the installation form is made of plastic polymer.

4. The device of claim 1, wherein the installation form has an aperture in the horizontal surface.

5. The device of claim 1, wherein the enclosure is removably attached to the installation form.

6. The device of claim 1, wherein the enclosure is attached to the installation form.

7. The device of claim 1, wherein the horizontal surface is mounted on adjustment bolts allowing the horizontal surface to be raised and lowered.

8. The device of claim 1, wherein the lens is coated with a material capable of protecting sensitive electrics from damaging ultraviolet radiation.

9. The device of claim 1, wherein the enclosure includes a modular design that provides an insulating barrier between the heat sensitive electronics from the heat generating electronics.

10. The device of claim 1, wherein the switch is comprised of a handheld radio frequency transmitter and a radio frequency receiver.

11. The device of claim 9, wherein the radio frequency receiver is coupled with an antenna to extend the operating radius of the radio frequency receiver.

12. The device of claim 9, wherein the handheld radio frequency transmitter and radio frequency receiver use with rolling codes to protect against accidental activation by other radio frequency transmitters in close proximity.

13. The device of claim 1, where the switch includes wireless communication selected from WIFI®, cellular telephone network, Bluetooth®, and ZigBee®.

14. The device of claim 1, wherein the switch is an activation switch mounted in the structure and connected to the distress signaling device.

15. The device of claim 1, wherein the solar cell is replaced by a battery charger connected to the structure's electrical circuit.

16. The device of claim 1, wherein rechargeable power source is mounted in the structure and charged by a battery charger connected to the structure's electrical circuit.

17. The device of claim 1, including an at least one signaling transmitter selected from COSPAS-SARSAT emergency beacon, cellular telephone enabled devices, GPS emergency beacon or other similar technology.

18. The device of claim 1, including a handheld radio frequency transmitter and radio frequency receiver capable of two way communication to activate the distress signaling device and notify the trapped survivor the distress signaling device successfully activated.

19. The device of claim 1, including a wireless video camera capable of recording the area surrounding the distress signaling device and providing trapped survivors with visual feedback.

20. The device of claim 1, including a handheld radio frequency transmitter and radio frequency receiver capable of two way communication to notify the trapped survivor rescuers have arrived.

21. A method of using a distress signaling device to aid in the rescue of a trapped survivor in a structure, comprising:
a. a means to quickly and easily anchor the distress signaling device in the ground with no specialized tools or knowledge,
b. providing a water resistant enclosure for the distress signaling device
c. providing a means for remotely activating the distress signaling device,
d. emitting an alarm and a high intensity light until the trapped survivors are removed from the structure
whereby the consumer can enlist any individual located near the structure as a potential rescuer, without the need of locating equipment or training, simply by following the sound and light emitted from said distress signaling device to the collapsed structure.

22. The method of claim 21, wherein a decision controller after a predetermined interval of time suppresses the alarm and high intensity light for a period of time and if a deactivation signal is not received by the distress signal device the alarm and high intensity light resume.

23. The method of claim 21, wherein a decision controller suppresses the alarm and high intensity light upon arrival of first responders on the scene.

24. A method for installing a distress signaling device comprising of:
a. selecting suitable location for the distress signaling device,
b. providing an installation form including
i. an open top,
ii. a horizontal surface,
iii. an aperture in the horizontal surface,
iv. vertical surfaces with ports
c. providing a water resistant enclosure the distress signaling device that is removably attached to said installation form,
d. the installation form is placed in a depression in the ground with dimensions larger than the installation form,
e. a composite material is poured through the aperture of the horizontal surface of the installation form and flows through the ports in the vertical surfaces of the installation form filling the voids surrounding the installation form and encapsulating the installation form in composite material,
whereby the installation form integrates with the composite material creating an anchor that makes the distress signaling system immovable.

25. The method of claim 24, providing adjustment bolts for the horizontal surface of the installation form allowing the distress signaling device to be raised or lowered.

26. The method of claim 24, providing a water resistant enclosure that is attached to the installation form.
